(19) United States
(12) Patent Application Publication
(10) Pub. No.: US 2017/0316867 A1
(43) Pub. Date: Nov. 2, 2017

(54) COIL COMPONENT AND POWER SUPPLY CIRCUIT UNIT

(71) Applicant: TDK CORPORATION, Tokyo (JP)

(72) Inventors: Akifumi KAMIJIMA, Tokyo (JP); Masamichi TANIGUCHI, Tokyo (JP); Makoto ENDO, Tokyo (JP); Tohru INOUE, Tokyo (JP)

(73) Assignee: TDK CORPORATION, Tokyo (JP)

(21) Appl. No.: 15/495,258

(22) Filed: Apr. 24, 2017

(30) Foreign Application Priority Data
Apr. 27, 2016 (JP) 2016-089434

(51) Int. Cl. H01F 27/28; H02M 3/156

(52) U.S. Cl. CPC H01F 27/2804; H02M 3/156; H01F 2027/2809

(57) ABSTRACT

Provided is a coil component including a coil portion that has two ring-shaped planar coil portions individually including a coil-wound portion and an insulative resin layer which covers the periphery of the coil-wound portion within the same layer as the coil-wound portion, an insulative resin layer being interposed between the planar coil portions adjacent to each other in the stacking direction of the planar coil portions, and a pair of insulative resin layers being respectively positioned on one end side and the other end side of the two planar coil portions in the stacking direction; and a covering portion that covers the coil portion. In regard to the stacking direction, the thickness of the insulative resin layer is thinner than the thickness of each of the pair of insulative resin layers.

### CROSS-REFERENCE TO RELATED APPLICATIONS

This application is based upon and claims the benefit of priority from Japanese Patent Application No. 2016-89434, filed on Apr. 27, 2016, the entire contents of which are incorporated herein by reference.

### BACKGROUND OF THE INVENTION

### Field of the Invention

This disclosure relates to a coil component and a power supply circuit unit.

### Related Background Art

For example, as a coil component in the related art, Japanese Unexamined Patent Publication No. 2015-76606 (Patent Literature 1) discloses a coil component provided with a coil portion including a coil-wound portion and an insulative layer which covers the coil-wound portion, within an element body.

Density of a magnetic flux relates to the volume of the element body. However, in the coil component disclosed in Patent Literature 1, increasing the volume of the element body is not sufficiently considered, and there is room for enhancing inductance. Furthermore, in the coil component disclosed in Patent Literature 1, high positional stability of the coil portion within the element body is required. In a coil component having low positional stability of the coil portion within the element body, positional deviation of the coil portion is likely to be caused due to thermal history or the like, thereby resulting in a change in inductance.

According to this disclosure, there are provided a coil component in which high inductance can be obtained and a change in inductance can be prevented, and a power supply circuit unit.

According to an aspect of this disclosure, there is provided a coil component including a coil portion that has a plurality of ring-shaped planar coil portions individually including a coil-wound portion and an intra insulative layer which covers the periphery of the coil-wound portion within the same layer as the coil-wound portion, an inter insulative layer being interposed between the planar coil portions adjacent to each other in a stacking direction of the planar coil portions, and a pair of extra insulative layers being respectively positioned on one end side and the other end side of the plurality of planar coil portions in the stacking direction; and a covering portion that covers the coil portion. In regard to the stacking direction, the thickness of the inter insulative layer is thinner than the thickness of each of the pair of extra insulative layers.

In the coil component, compared to a coil component in which the thickness of the inter insulative layer and the thickness of the pair of extra insulative layers are equal to each other, a gap between the planar coil portions adjacent to each other in the stacking direction becomes narrow. Thus, a stacking-directional clearance between the coil-wound portions in the planar coil portions adjacent to each other in the stacking direction becomes short. As a result, generation efficiency of a magnetic field is enhanced in the coil portion in its entirety. Besides, in a case where the external dimensions of the coil component are the same, the covering portion which covers the coil portion can be thickened and the volume of the covering portion can be increased as much as the narrowed gap between the planar coil portions. As the result thereof, the maximum density of a magnetic flux generated within the covering portion is enhanced, and high inductance can be obtained. Moreover, the inter insulative layer interposed between the planar coil portions is thin. Therefore, even in a case where thermal history or the like is received, the gap between the planar coil portions becomes stable. Thus, positional deviation of the coil portion caused within the covering portion due to thermal history or the like can be prevented. As a result, a change in inductance can be prevented.

In the coil component according to an aspect of this disclosure, when viewed in the stacking direction, the inter insulative layer may exhibit a ring shape corresponding to forming regions of the planar coil portions adjacent to each other in the stacking direction.

In the coil component according to an aspect of this invention, when viewed in the stacking direction, each of the pair of extra insulative layers may have a ring-shaped portion corresponding to the forming regions of the planar coil portions adjacent to each other in the stacking direction, and the extra insulative layer positioned on the one end side of the plurality of planar coil portions in the stacking direction may have a solid portion filling the inside of the ring-shaped portion.

According to another aspect of the present invention, there is provided a power supply circuit unit including the coil component described above. According to such a power supply circuit unit, high inductance can be obtained, and a change in inductance can be prevented.

### BRIEF DESCRIPTION OF THE DRAWINGS

FIG. 1 is a perspective view illustrating a power supply circuit unit according to an embodiment of this disclosure.

FIG. 2 is a view illustrating an equivalent circuit of the power supply circuit unit illustrated in FIG. 1.

FIG. 3 is a perspective view of a coil component according to the embodiment of this disclosure.

FIG. 4 is a sectional view of the coil component in FIG. 3 taken along line IV-IV.

FIG. 5 is an exploded perspective view of the coil component in FIG. 3.

FIGS. 6A and 6B are top views respectively illustrating insulative resin layers in FIG. 5.

FIGS. 7A to 7D are views describing a step of making the coil component in FIG. 3.

FIGS. 8A to 8D are views describing the step of making the coil component in FIG. 3.

FIGS. 9A to 9D are views describing the step of making the coil component in FIG. 3.

FIG. 10 is a view for describing an action and an effect of the coil component in FIG. 3.

### DESCRIPTION OF THE PREFERRED EMBODIMENT

Hereinafter, an embodiment of this disclosure will be described in detail with reference to the accompanying drawings. In the description, the same reference signs are assigned to the same elements or elements having the same functions, and duplicated description will be omitted.

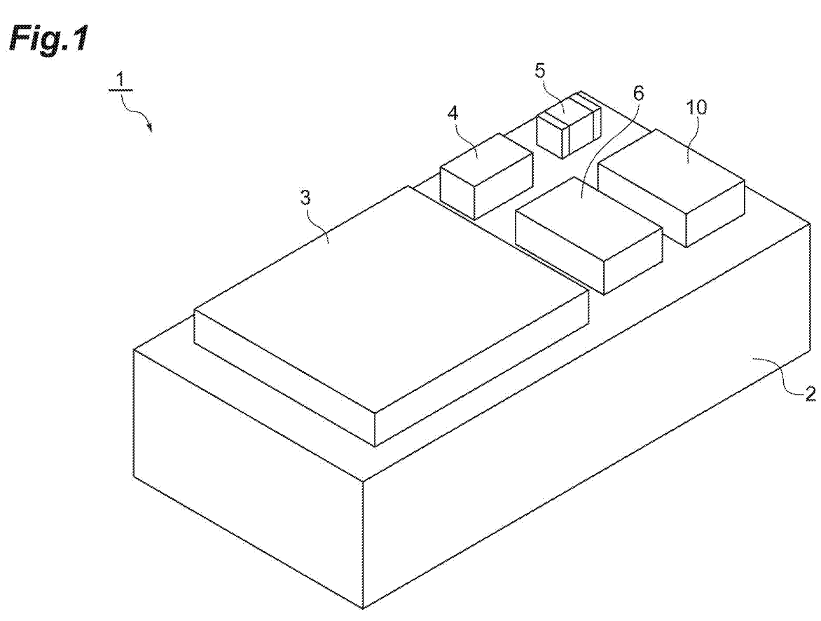

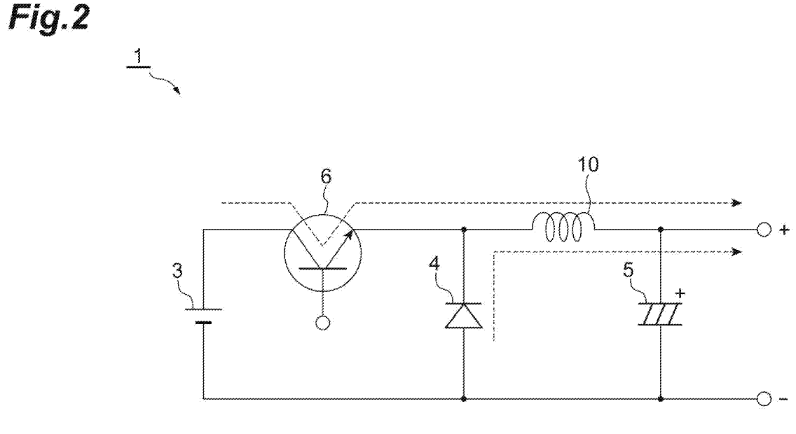

First, with reference to FIGS. 1 and 2, the entire configuration of a power supply circuit unit 1 according to the embodiment of the present invention will be described. For example, a power supply circuit unit to be described in the present embodiment is a switching power supply circuit unit that converts (steps down) a direct voltage. As illustrated in FIGS. 1 and 2, the power supply circuit unit 1 includes a circuit substrate 2 and electronic components 3, 4, 5, 6, and 10. Specifically, a power supply IC 3, a diode 4, a capacitor 5, a switching element 6, and a coil component 10 are configured to be mounted on the circuit substrate 2.

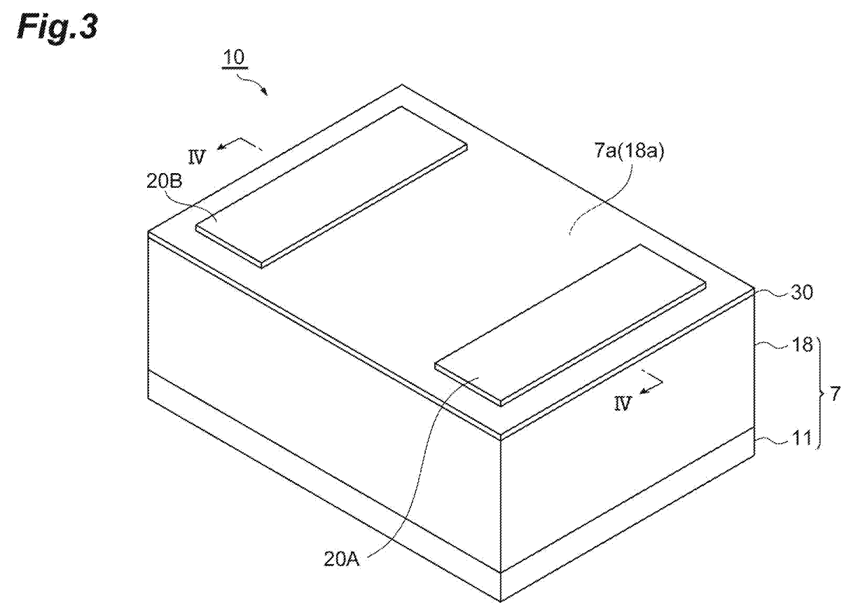

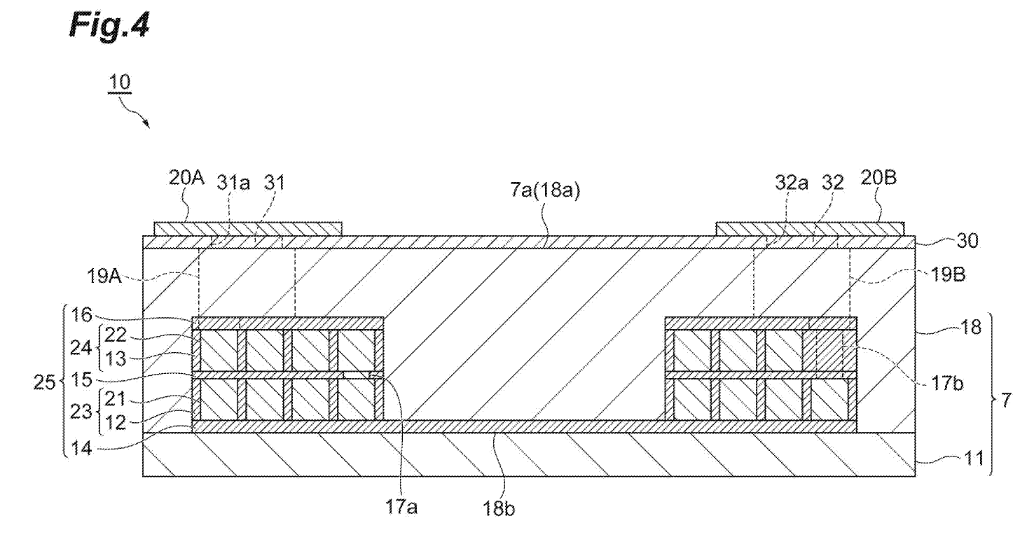

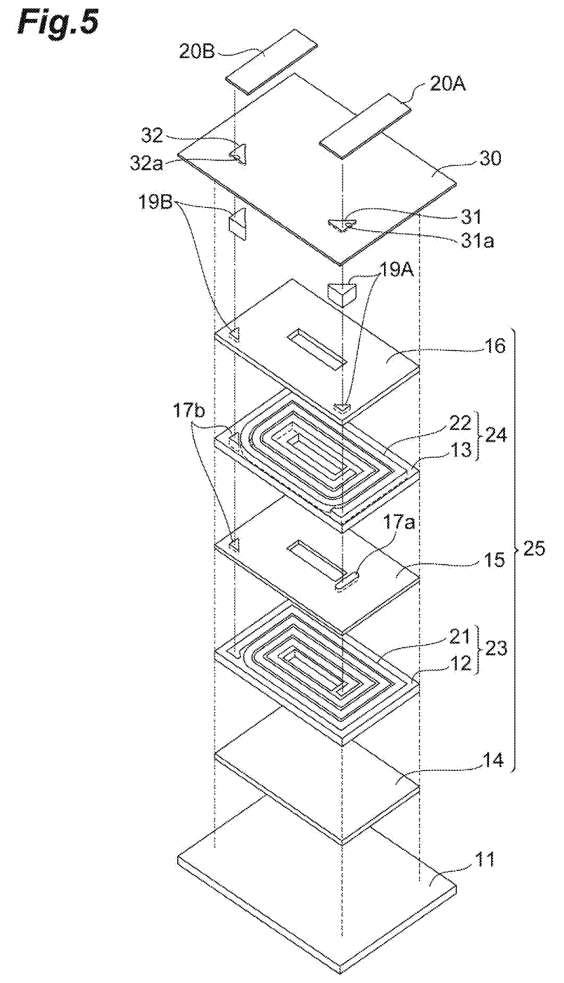

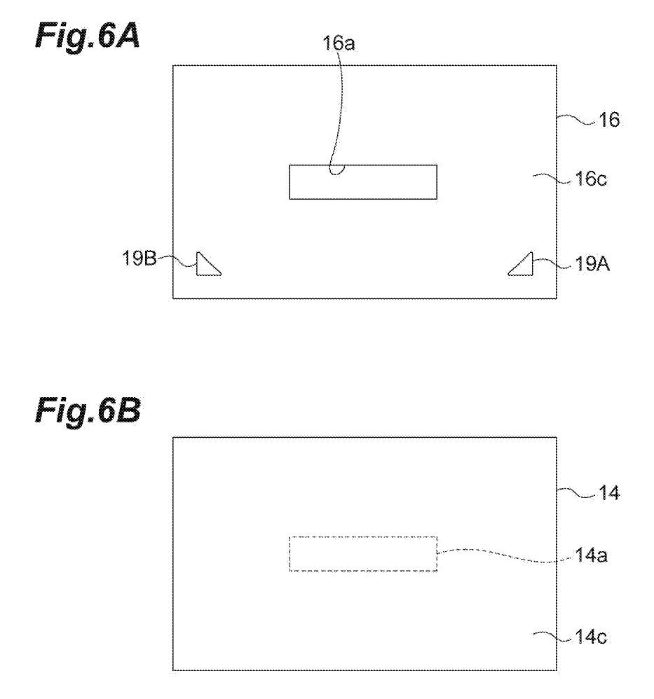

With reference to FIGS. 3 to 6, the configuration of the coil component 10 will be described. FIG. 3 is a perspective view of the coil component 10. FIG. 4 is a sectional view of the coil component 10 taken along line IV-IV. FIG. 5 is an exploded perspective view of the coil component 10. The exploded perspective view of FIG. 5 does not illustrate a magnetic resin layer 18 in FIG. 3. FIGS. 6A and 6B are top views respectively illustrating insulative resin layers 14 and 16 in FIG. 5. FIG. 6A illustrates the insulative resin layer 16, and FIG. 6B illustrates the insulative resin layer 14.

As illustrated in FIG. 3, the coil component 10 includes a coil portion 25 (will be described later), a covering portion 7 covering the coil portion 25, and an insulative layer 30 provided on a main surface 7a of the covering portion 7. The covering portion 7 has a rectangular parallelepiped exterior. The main surface 7a of the covering portion 7 has a rectangular shape having long sides and short sides. As an example of the external dimensions of the covering portion 7, the length of the short side is approximately 2.0 mm, the length of the long side is approximately 3.0 mm, and the thickness is approximately 0.3 mm. Examples of the rectangular shape include a rectangular shape having rounded corners. Examples of the rectangular parallelepiped shape include a rectangular parallelepiped shape having chamfered corners and ridge portions, and a rectangular parallelepiped shape having rounded corners and ridge portions. For example, the covering portion 7 is configured to be formed of a magnetic material. Specifically, the covering portion 7 is configured to include a magnetic substrate 11 and the magnetic resin layer 18.

Terminal electrodes 20A and 20B are provided on the main surface 7a via the insulative layer 30. The terminal electrode 20A is disposed along one short side of the main surface 7a, and the terminal electrode 20B is disposed along the other short side of the main surface 7a. The terminal electrodes 20A and 20B are spaced away from each other in a direction along the long side of the main surface 7a.

For example, the magnetic substrate 11 is a substantially flat substrate configured to be formed of a magnetic material such as ferrite (refer to FIG. 5). The magnetic substrate 11 is positioned on a side of the covering portion 7 which is opposite to the main surface 7a. The magnetic resin layer 18 and the coil portion 25 (will be described later) are formed in the magnetic substrate 11.

The magnetic resin layer 18 is formed on the magnetic substrate 11. A surface 18a on a side opposite to a surface 18b on the magnetic substrate 11 side of the magnetic resin layer 18 configures the main surface 7a of the covering portion 7. The magnetic resin layer 18 is a mixture of magnetic powder and binder resin. For example, the configuration material of the magnetic powder is iron, carbonyl iron, silicon, chromium, nickel, or boron. For example, the configuration material of the binder resin is epoxy resin. The magnetic resin layer 18 may be configured to be formed of the magnetic powder 90% or more in its entirety.

Each of a pair of terminal electrodes 20A and 20B provided on the main surface 7a of the covering portion 7 has a shape of a film, and has a substantially rectangular shape in a top view. The terminal electrodes 20A and 20B have areas substantially the same as each other. For example, the terminal electrodes 20A and 20B are configured to be formed of conductive materials such as Cu. The terminal electrodes 20A and 20B are plating electrodes formed via plating. The terminal electrodes 20A and 20B may have single-layer structures or multi-layer structures.

The insulative layer 30 provided on the main surface 7a of the covering portion 7 is interposed between the pair of terminal electrodes 20A and 20B on the main surface 7a. In the present embodiment, the insulative layer 30 is provided in such a manner as to cover the entire region of the main surface 7a and includes a portion which extends in a direction intersecting the long-side direction (direction in which the pair of terminal electrodes 20A and 20B is adjacent to each other) and traverses the main surface 7a. The insulative layer 30 has through holes 31a and 32a (apertures) at positions corresponding to lead-out conductors 19A and 19B. Inside the through holes 31a and 32a, there are provided conductor portions 31 and 32 configured to be formed of conductive materials such as Cu. The insulative layer 30 is configured to be formed of an insulative material. For example, the insulative layer 30 is configured to be formed of insulative resin such as polyimide and epoxy.

As illustrated in FIGS. 4 and 5, the coil portion 25 and the lead-out conductors 19A and 19B are disposed within the magnetic resin layer 18.

The coil portion 25 has a plurality (in the present embodiment, two) of ring-shaped planar coil portions 23 and 24, a plurality layers (in the present embodiment, three layers) of insulative resin layers 14 to 16 overlapping the planar coil portions 23 and 24, and connection portions 17a and 17b.

The planar coil portion 23 and the planar coil portion 24 are arranged side by side in a direction orthogonal to the main surface 7a, and the planar coil portion 24 is positioned closer to the main surface 7a side than the planar coil portion 23. Each of the planar coil portions 23 and 24 is symmetrical in shape in a top view (specifically, a rectangular shape). In the present embodiment, the planar coil portion 23 and the planar coil portion 24 have dimensions substantially the same as each other. That is, the planar coil portion 23 and the planar coil portion 24 exhibit rectangular ring shapes having the same outer edge dimensions and inner edge dimensions as each other in a top view, and forming regions thereof completely coincide with each other.

The planar coil portion 23 has a coil-wound portion 21 and an insulative resin layer 12 which are positioned together in the same layer. The coil-wound portion 21 is rectangularly wound in a top view. For example, the coil-wound portion 21 is configured to be formed of a metal material such as Cu. The insulative resin layer 12 (intra insulative layer) covers the periphery of the coil-wound portion 21 within the same layer as the coil-wound portion 21. Specifically, the insulative resin layer 12 fills the periphery (inner peripheral side and outer peripheral side) of a coil-wound portion 22 within the same layer, and gaps between windings.

The planar coil portion 24 has the coil-wound portion 22 and an insulative resin layer 13 which are positioned together in the same layer. The coil-wound portion 22 is rectangularly wound in a top view. The winding direction of the coil-wound portion 22 is the same as the winding direction of the coil-wound portion 21. For example, the coil-wound portion 22 is configured to be formed of a metal material such as Cu. The insulative resin layer 13 (intra insulative layer) covers the periphery of the coil-wound portion 22 within the same layer as the coil-wound portion 22. Specifically, the insulative resin layer 13 fills the periphery (inner peripheral side and outer peripheral side) of the coil-wound portion 22 within the same layer, and gaps between windings.

The insulative resin layers 14 to 16 are provided in order of the insulative resin layer 14, the insulative resin layer 15, and the insulative resin layer 16 from the magnetic substrate 11 side. Each of the planar coil portions 23 and 24 is interposed between insulative resin layers adjacent to each other in a stacking direction (that is, the stacking direction of the planar coil portions 23 and 24). That is, the planar coil portion 23 is interposed between the insulative resin layer 14 and the insulative resin layer 15, and the planar coil portion 24 is interposed between the insulative resin layer 15 and the insulative resin layer 16.

The insulative resin layer 14 (extra insulative layer) is positioned below the planar coil portion 23 (magnetic substrate 11 side). That is, the insulative resin layer 14 is positioned on one end side of the two planar coil portions 23 and 34 in the stacking direction and is adjacent to the planar coil portion 23. The insulative resin layer 14 faces the planar coil portion 23 from the magnetic substrate 11 side and overlaps the planar coil portion 23. As illustrated in FIG. 6B, when viewed in the stacking direction, the insulative resin layer 14 has a ring-shaped portion 14c corresponding to the forming region of the planar coil portion 23, and a solid portion 14a filling the inside of the ring-shaped portion 14c. That is, the insulative resin layer 14 exhibits a rectangular shape corresponding to the shape of the outer peripheral edge of the forming region of the planar coil portion 23.

The insulative resin layer 16 (extra insulative layer) is positioned above the planar coil portion 24 (main surface 7a side). That is, the insulative resin layer 16 is positioned on the other end side of the two planar coil portions 23 and 24 in the stacking direction and is adjacent to the planar coil portion 24. The insulative resin layer 16 faces the planar coil portion 24 from the main surface 7a side and overlaps the planar coil portion 24. As illustrated in FIG. 6A, when viewed in the stacking direction, a central opening portion 16a is formed in the insulative resin layer 16, which has a ring-shaped portion 16c corresponding to the forming region of the planar coil portion 24. That is, the insulative resin layer 16 exhibits a rectangular ring shape corresponding to the outer shape (shape of the outer peripheral edge and shape of the inner peripheral edge) of the forming region of the planar coil portion 24.

The insulative resin layer 15 (inter insulative layer) is positioned between the planar coil portion 23 and the planar coil portion 24. That is, the insulative resin layer 15 is interposed between the planar coil portions 23 and 24 adjacent to each other in the stacking directions and is adjacent to the planar coil portions 23 and 24. The insulative resin layer 15 faces the planar coil portion 24 from the magnetic substrate 11 side and overlaps the planar coil portion 24. The insulative resin layer 15 faces the planar coil portion 23 from the main surface 7a side and overlaps the planar coil portion 23. When viewed in the stacking direction, the insulative resin layer 16 exhibits a ring shape corresponding to the forming regions of the planar coil portions 23 and 24.

with reference to FIG. 4, the thicknesses of the insulative resin layers 14 to 16 in the stacking direction will be described (hereinafter, the thickness related to the stacking direction will be simply referred to as “thickness”). As illustrated in FIG. 4, the thickness of the insulative resin layer 15 interposed between the planar coil portions 23 and 24 is thinner than the thickness of each of the insulative resin layer 14 positioned below the planar coil portion 23 and the insulative resin layer 16 positioned above the planar coil portion 24. Accordingly, compared to a case where the thicknesses of the insulative resin layers 14 to 16 are equal to each other, a gap between the planar coil portions 23 and 24 is narrow. In a case where the external dimensions of the coil component are the same, the covering portion 7 which covers the coil portion 25 can be thickened and the volume of the covering portion 7 can be increased as much as the narrowed gap between the planar coil portions 23 and 24. That is, compared to a case where the thicknesses of the insulative resin layers 14 to 16 are equal to each other, the volume of the magnetic resin layer 18 present on the upper layer (main surface 7a) side of the coil portion 25 can be increased.

Each of the above-described insulative resin layers 12 to 16 is insulative and is configured to be formed of insulative resin. Examples of the insulative resin include polyimide, acryl, and epoxy. The insulative resin layers 12 to 16 are bound together in the stacking direction and are integrated to the extent that the boundaries among the insulative resin layers 12 to 16 cannot visually recognized in practice. The insulative resin layers 12 to 16 cover the upper surface (surface on the main surface 7a side), the lower surface (surface on the magnetic substrate 11 side), and the side surface (surface parallel to the stacking direction) of each of the coil-wound portions 21 and 22.

The connection portion 17a is positioned in the same layer as the insulative resin layer 15 and penetrates the insulative resin layer 15. The connection portion 17a is interposed between the coil-wound portion 21 and the coil-wound portion 22, thereby connecting winding of the coil-wound portion 21 on the innermost side and winding of the coil-wound portion 22 on the innermost side together. The connection portion 17b penetrates the insulative resin layers 13 and 15 from the winding of the coil-wound portion 21 on the outermost side and extends to the main surface 7a side, thereby connecting the coil-wound portion 21 and the lead-out conductor 19B together. For example, the connection portions 17a and 17b are configured to be formed of metal materials such as Cu.

For example, the lead-out conductors 19A and 19B are configured to be formed of metal materials such as Cu. The lead-out conductor 19A is connected to the winding of the coil-wound portion 22 on the outermost side. The lead-out conductor 19A extends from the winding of the coil-wound portion 22 on the outermost side to the main surface 7a of the covering portion 7 in such a manner as to penetrate the insulative resin layer 16 and the magnetic resin layer 18, thereby being exposed through the main surface 7a. The terminal electrode 20A is provided on the main surface 7a at a position corresponding to the exposed portion of the lead-out conductor 19A. The lead-out conductor 19A is connected to the terminal electrode 20A through the conductor portion 31 inside the through hole 31a of the insulative layer 30. Accordingly, the winding of the coil-wound portion 22 on the outermost side and the terminal electrode 20A are electrically connected to each other via the lead-out conductor 19A and the conductor portion 31.

The lead-out conductor 19B connected to the winding of the coil-wound portion 21 on the outermost side. The lead-out conductor 19B extends from the connection portion 17b to the main surface 7a of the covering portion 7 in such a manner as to penetrate the insulative resin layer 16 and the magnetic resin layer 18, thereby being exposed through the main surface 7a. The terminal electrode 20B is provided on the main surface 7a at a position corresponding to the exposed portion of the lead-out conductor 19B. The lead-out conductor 19B is connected to the terminal electrode 20B through the conductor portion 32 inside the through hole 32a of the insulative layer 30. Accordingly, the winding of the coil-wound portion 21 on the outermost side and the terminal electrode 20B are electrically connected to each other via the connection portion 17b, the lead-out conductor 19B, and the conductor portion 32.

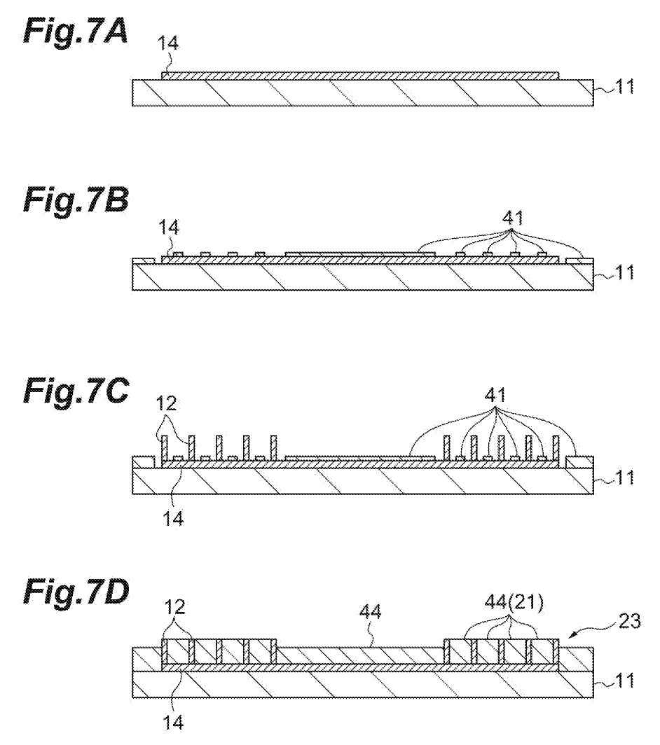

Next, with reference to FIGS. 7A to 9D, a method of making a coil component 10 will be described. FIGS. 7A to 9D are views describing a step of making a coil component 10.

First, as illustrated in FIG. 7A, after the magnetic substrate 11 is coated with insulative resin, patterning is performed through a technique such as photolithography, thereby forming the insulative resin layer 14. Subsequently, as illustrated in FIG. 7B, seed portions 41 for forming the coil-wound portion 21 via plating are formed on the insulative resin layer 14. The seed portions 41 can be formed through plating, sputtering, or the like by using a predetermined mask. Subsequently, as illustrated in FIG. 7C, the insulative resin layer 12 is formed. After the entire surface of the magnetic substrate 11 is coated with the insulative resin, the insulative resin layer 12 can be obtained by removing the insulative resin corresponding to the portions of the seed portions 41 through patterning performed by using the technique such as photolithography. That is, the insulative resin layer 12 has a function of exposing the seed portions 41. The insulative resin layer 12 is a wall-like portion standing on the magnetic substrate 11 and divides the regions where the coil-wound portion 21 is formed. Subsequently, as illustrated in FIG. 7D, a plating layer 44 is formed in gaps among the insulative resin layers 12 by using the seed portions 41. In this case, the plating which is developed in such a manner as to fill the divided regions among the insulative resin layers 12 becomes the coil-wound portion 21. As a result, the winding of the coil-wound portion 21 is positioned between the insulative resin layers 12 adjacent to each other, thereby forming the planar coil portion 23 having the coil-wound portion 21 and the insulative resin layer 12.

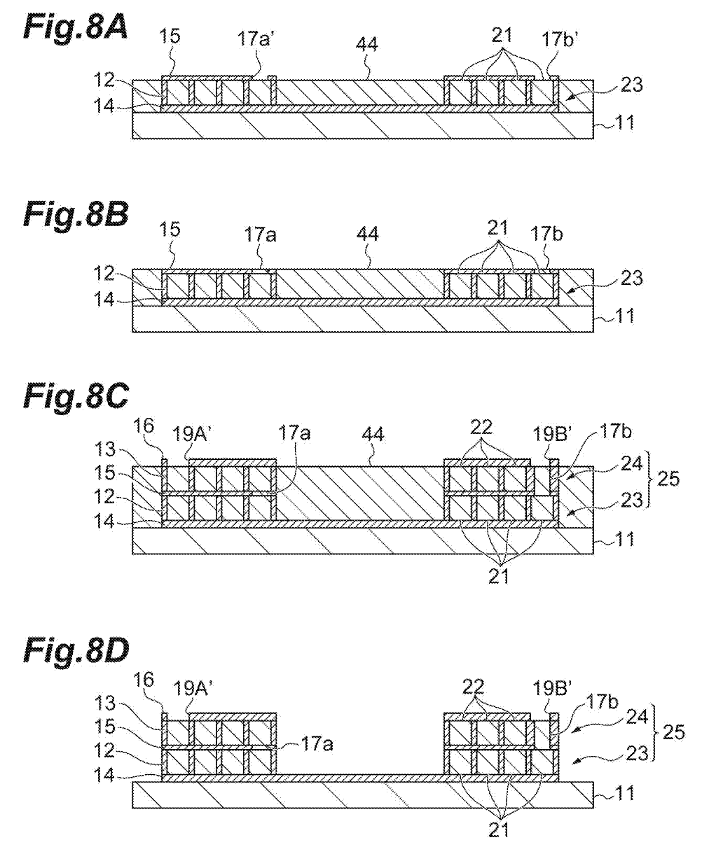

Subsequently, as illustrated in FIG. 8A, after the coil-wound portion 21 is coated with insulative resin, patterning is performed through a technique such as photolithography, thereby forming the insulative resin layer 15. In this case, opening portions 17a′ and 17b′ for forming the connection portions 17a and 17b are formed in the insulative resin layer 15. Subsequently, as illustrated in FIG. 8B, the connection portions 17a and 17b are respectively formed in the opening portions 17a′ and 17b′ of the insulative resin layer 15 via plating.

Subsequently, as illustrated in FIG. 8C, similar to the step described above, the coil-wound portion 22 and the insulative resin layers 13 and 16 are formed on the insulative resin layer 15. Specifically, similar to the procedures illustrated in FIGS. 7B to 7D, seed portions for forming the coil-wound portion 22 via plating are formed and the insulative resin layer 13 which divides the regions for forming the coil-wound portion 22 is formed, thereby forming the coil-wound portion 22 among the insulative resin layers 13 via plating. As a result, the winding of the coil-wound portion 22 is positioned between the insulative resin layers 13 adjacent to each other, thereby forming the planar coil portion 24 having the coil-wound portion 22 and the insulative resin layer 13. As described above, the coil portion 25 having the planar coil portions 23 and 24, the insulative resin layers 14 to 16 respectively overlapping the planar coil portions 23 and 24, and the connection portions 17a and 17b is formed.

After the coil-wound portion 22 is coated with insulative resin, patterning is performed through a technique such as photolithography, thereby forming the insulative resin layer 16. In this case, opening portions 19A′ and 19B′ for forming the lead-out conductors 19A and 19B are formed in the insulative resin layer 16.

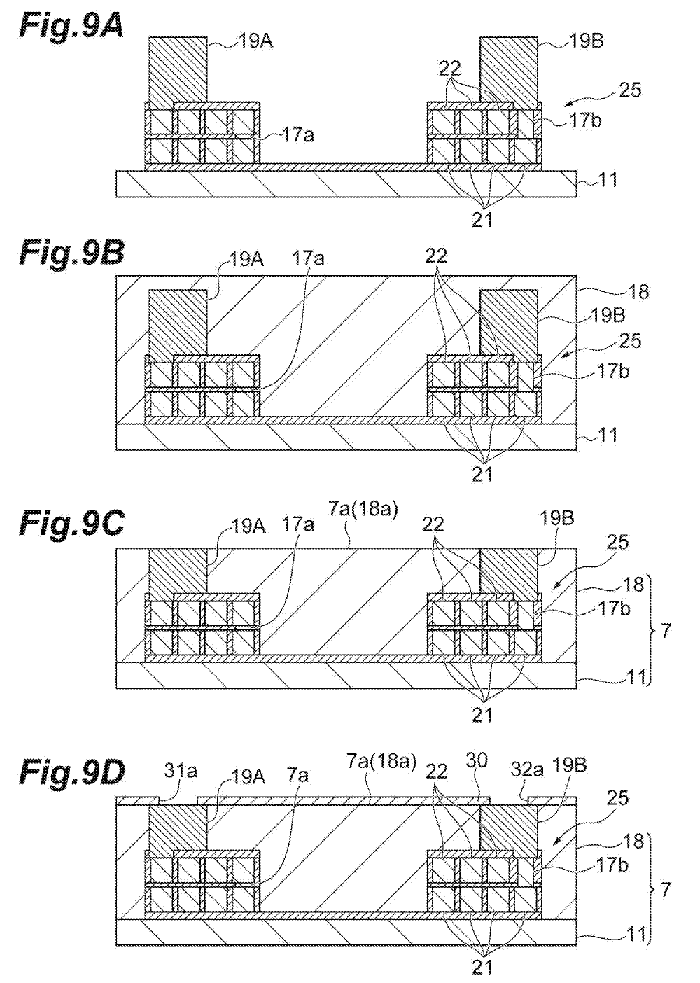

Subsequently, as illustrated in FIG. 8D, in the plating layer 44, portions not configuring the coil-wound portions 21 and 22 (portions corresponding to the inner peripheral portions and the outer peripheral portions of the coil-wound portions 21 and 22) are removed through etching. In other words, the plating layer 44 which is not covered with the insulative resin layers 12 to 16 in FIG. 8C is removed. Subsequently, as illustrated in FIG. 9A, the lead-out conductor 19A is formed at a position corresponding to the opening portion 19A′ of the insulative resin layer 16, and the lead-out conductor 19B is formed at a position corresponding to the opening portion 19B′. Specifically, seed portions for the lead-out conductors 19A and 19B are respectively formed on the opening portions 19A′ and 19B′ through plating, sputtering, or the like by using a predetermined mask, thereby forming the lead-out conductors 19A and 19B via plating by using the seed portions.

Subsequently, as illustrated in FIG. 9B, the entire surface of the magnetic substrate 11 is coated with magnetic resin and predetermined hardening is performed, thereby forming the magnetic resin layer 18. Accordingly, the peripheries of the coil portion 25 and the lead-out conductors 19A and 19B are covered with the magnetic resin layer 18. In this case, the inner diameter portion of the coil portion 25 is filled with the magnetic resin layer 18. Subsequently, as illustrated in FIG. 9C, grinding is performed such that the lead-out conductors 19A and 19B are exposed from the magnetic resin layer 18.

According to the step described above, it is possible to obtain the covering portion 7 in which the lead-out conductors 19A and 19B are exposed through the main surface 7a of the covering portion 7, thereby ending the step of preparing the covering portion 7.

Subsequently, as illustrated in FIG. 9D, before the terminal electrodes 20A and 20B are formed via plating, the main surface 7a is coated with insulative resin. Thereafter, patterning is performed through a technique such as photolithography, thereby forming the insulative layer 30. When the insulative layer 30 is formed, the main surface 7a in its entirety is covered, the through holes 31a and 32a are formed at positions corresponding to the pair of lead-out conductors 19A and 19B, and the pair of lead-out conductors 19A and 19B are exposed through the insulative layer 30. Specifically, the entire region of the main surface 7a is temporarily coated with the insulative material. Thereafter, the insulative layer 30 at spots corresponding to the lead-out conductors 19A and 19B is removed.

On the insulative layer 30, seed portions (not illustrated) are formed in the regions corresponding to the terminal electrodes 20A and 20B through plating, sputtering, or the like by using a predetermined mask. The seed portions are also formed on the lead-out conductors 19A and 19B exposed through the through holes 31a and 32a of the insulative layer 30. Subsequently, the terminal electrodes 20A and 20B are formed through electroless plating or the like by using the seed portions. In this case, the plating is developed in such a manner as to fill the through holes 31a and 32a of the insulative layer 30, thereby forming the conductor portions 31 and 32 and forming the terminal electrodes 20A and 20B on the insulative layer 30. In this manner, the coil component 10 is formed.

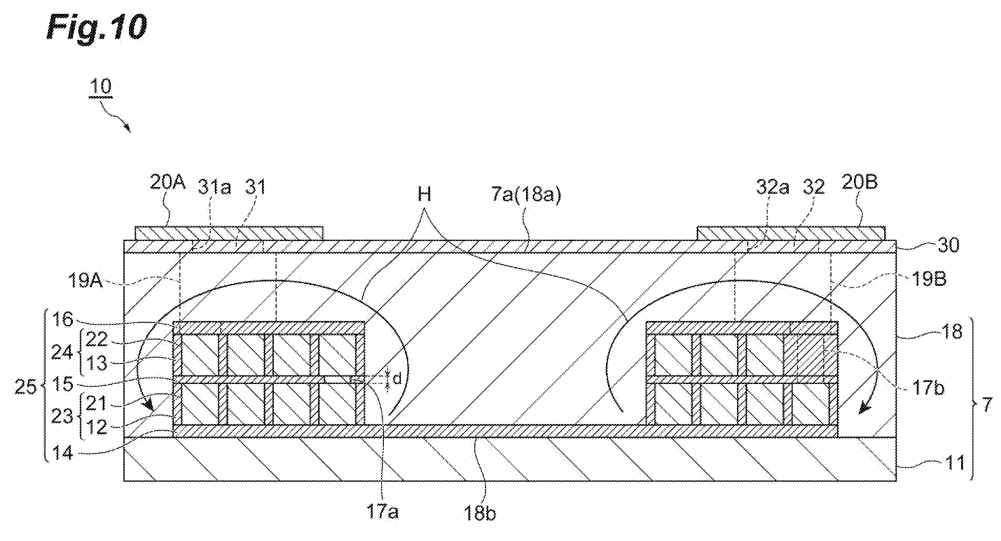

Next, with reference to FIG. 10, an action and an effect of the coil component 10 will be described. FIG. 10 is a view for describing the action and the effect of the coil component 10 and corresponds to FIG. 4.

As illustrated in FIG. 10, within the covering portion 7 of the coil component 10, a magnetic field H is generated on the periphery of the coil portion 25. Here, the stacking-directional clearance between the coil-wound portions 21 and 22 within the coil portion 25 becomes shorter when the thickness of the insulative resin layer 15, that is, a gap d between the planar coil portion 23 and the planar coil portion 24 becomes smaller. Therefore, the generation efficiency of the magnetic field H in the coil portion 25 in its entirety increases when the gap d between the planar coil portions 23 and 24 becomes smaller. In addition, in a case where the external dimensions of the coil portion are the same as each other, the ratio of the coil-wound portions 21 and 22 which are conductor portions within the coil portion 25 can be increased as much as the reduced gap d between the planar coil portions 23 and 24. Therefore, the generation efficiency of the magnetic field H is further improved. Besides, in a case where the external dimensions of the coil component are the same as each other, the magnetic resin layer 18 of the covering portion 7 which covers the coil portion 25 can be thickened and the volume of the magnetic resin layer 18 can be increased as much as the reduced gap d between the planar coil portions 23 and 24. As the result thereof, the maximum density of a magnetic flux generated within the covering portion 7 is enhanced, and high inductance can be obtained.

Moreover, when there is a change in the temperature of the coil component 10, it is possible to assume a case where the thicknesses of the planar coil portions 23 and 24, the insulative resin layer 15, and the like change due to thermal expansion, thermal contraction, or the like, thereby resulting in a change in the gap d between the planar coil portions 23 and 24. Even in such a case, in a case where the gap d between the planar coil portions 23 and 24 is sufficiently small, a change amount Δd caused due to thermal history (thermal expansion or thermal contraction) can be reduced. Thus, even in a case where the thermal history or the like is received, the change amount of the gap d between the planar coil portions 23 and 24 can be reduced, and the gap d can be stable.

Hereinbefore, according to the coil component 10 of the present embodiment, since the thickness of the insulative resin layer 15 is thinner than the thicknesses of a pair of insulative resin layers 14 and 16, compared to a coil component in which the thicknesses are equal to each other, the gap d between the planar coil portions 23 and 24 adjacent to each other in the stacking directions becomes narrow. Thus, the stacking-directional clearance between the coil-wound portions 21 and 22 in the planar coil portions 23 and 24 adjacent to each other in the stacking directions becomes short. As a result, the generation efficiency of a magnetic field in the coil portion 25 in its entirety is enhanced. Besides, in a case where the external dimensions of the coil component are the same as each other, the covering portion 7 which covers the coil portion 25 can be thickened and the volume of the covering portion 7 can be increased as much as the reduced gap between the planar coil portions 23 and 24. As the result thereof, high inductance can be obtained. Moreover, since the insulative resin layer 15 interposed between the planar coil portions 23 and 24 is thin, even in a case where the thermal history or the like is received, the gap between the planar coil portions 23 and 24 becomes stable. Thus, positional deviation of the coil portion 25 caused within the covering portion 7 due to thermal history or the like can be prevented. As a result, a change in inductance can be prevented.

In addition, according to the power supply circuit unit 1 of the present embodiment including the coil component 10, high inductance can be obtained, and a change in inductance can be prevented.

### EXAMPLE

Hereinafter, in order to describe the effect thereof, Examples executed by the inventors will be described. The present invention is not limited to the following Examples. In the following Comparative Examples and Example, 100 coil components were prepared. Each of the coil components included a coil portion that had two ring-shaped planar coil portions individually including a coil-wound portion and an intra insulative layer which covered the periphery of the coil-wound portion within the same layer as the coil-wound portion, an inter insulative layer being interposed between the planar coil portions adjacent to each other in the stacking direction of the planar coil portions, and a pair of extra insulative layers being respectively positioned on one end side and the other end side of the two planar coil portions in the stacking direction; and a covering portion that covered the coil portion. As the external dimensions of the covering portion, the length of the short side was set to approximately 2.0 mm, the length of the long side was set to approximately 3.0 mm, and the thickness was set to approximately 0.3 mm, and the external dimensions were set to be the same in each of Comparative Examples and Example.

In the following Comparative Examples 1 to 3 and Example 1, the average value of the initial inductance was measured. In addition, thermal history was applied to the coil components by alternately repeating cooling at −20° C. for 5 minutes and heating at 40° C. for 5 minutes 100 times. Thereafter, the change amount in inductance was measured.

### Comparative Examples 1 and 2

In Comparative Examples 1 and 2, a coil component in which the thickness of the inter insulative layer was substantially the same as the thickness of the extra insulative layer was used. In Comparative Example 1, the thickness of each of the inter insulative layer and the extra insulative layer was set to 10 μm. In Comparative Example 2, the thickness of each of the inter insulative layer and the extra insulative layer was set to 5 μm.

### Comparative Example 3

In Comparative Example 3, a coil component in which the thickness of the inter insulative layer is thicker than the thickness of the extra insulative layer was used. In Comparative Example 3, the thickness of the inter insulative layer was set to 3 μm, and the thickness of the extra insulative layer was set to 5 μm.

### Example 1

In Example 1, a coil component in which the thickness of the inter insulative layer was thinner than the thickness of the extra insulative layer was used. In Example 1, the thickness of the inter insulative layer was set to 5 μm, and the thickness of the extra insulative layer was set to 3 μm.

### Result

Table 1 indicates the measurement results of Comparative Examples 1 to 3 and Example 1. Table 1 indicates the average value of the measurement results of the 100 prepared coil components.

TABLE 1

| | Thickness of | | | |
|---|---|---|---|---|
| | extra | Thickness of | | Change amount |
| | insulative | inter insulative | Inductance | of inductance |
| | layer (μm) | layer (μm) | (nH) | (%) |
| Comparative | 10 | 10 | 860 | 2.48 |
| Example 1 | | | | |
| Comparative | 5 | 5 | 922 | 0.71 |
| Example 2 | | | | |
| Comparative | 3 | 5 | 1015 | 0.45 |
| Example 3 | | | | |
| Example 1 | 5 | 3 | 1063 | 0.30 |

As illustrated in Table 1, in a case of Example 1, compared to any case of Comparative Examples 1 to 3, it was found that high inductance could be obtained and the change amount in inductance could be prevented.

Hereinbefore, the embodiment of the present invention has been described. However, the present invention may be modified or may be applied to a different aspect in the scope without changing the gist disclosed in each of the aspects of the invention.

For example, the coil portion 25 may have three or more planar coil portions and two layers or more inter insulative layers being interposed between the planar coil portions adjacent to each other in the stacking direction. In this case, the number of times of winding in the coil portion 25 increases, and it is possible to obtain a coil component 10 having higher inductance.

In a case where the coil portion 25 has two layers or more inter insulative layers, the thickness of any of the inter insulative layers may be thinner than the thicknesses of the pair of extra insulative layers. In this case, the thickness of any of the inter insulative layers may be selectively thinned.

In a case where the coil portion 25 has two layers or more inter insulative layers, the thicknesses of all of the inter insulative layers may be thinner than the thicknesses of the pair of extra insulative layers. In this case, the stacking-directional clearance between the coil-wound portions in all of the planar coil portions becomes short. Therefore, the generation efficiency of a magnetic field in the coil portion 25 in its entirety can be further enhanced, and the volume of the covering portion 7 can be further increased. As the result thereof, the maximum density of a magnetic flux generated within the covering portion can be further enhanced, and higher inductance can be obtained. Moreover, the gaps among all of the planar coil portions become stable. Therefore, positional deviation of the coil portion caused within the covering portion due to the thermal history or the like can be further prevented. As a result, a change in inductance can be further prevented.

The shapes of the insulative resin layers 14 to 16 are not limited to the embodiment described above. For example, the shapes do not have to correspond to the forming regions of the planar coil portions 23 and 24. In addition, the forming regions of the planar coil portions 23 and 24 do not have to completely coincide with each other.

In the aspect of the embodiment, the insulative layer 30 is provided in such a manner as to cover the main surface 7a of the covering portion 7 in its entirety. However, the embodiment is not limited thereto. The insulative layer 30 may be provided in at least a part between the pair of terminal electrodes 20A and 20B on the main surface 7a. For example, the insulative layer 30 may have a shape which extends in a direction intersecting the long-side direction of the main surface 7a (direction in which the pair of terminal electrodes 20A and 20B is adjacent to each other) and traverses the main surface 7a.

In the embodiment, the terminal electrodes 20A and 20B are provided on the insulative layer 30. However, the embodiment is not limited thereto. For example, through holes having the dimensions and the shape corresponding to the forming regions of the terminal electrodes 20A and 20B may be provided in the insulative layer 30, and the terminal electrodes 20A and 20B may be directly provided on the main surface 7a of the covering portion 7.

In the aspect of the embodiment, the terminal electrodes 20A and 20B and the conductor portions 31 and 32 are formed at one time. However, the terminal electrodes 20A and 20B and the conductor portions 31 and 32 may be separately formed. In this case, the configuration material of the terminal electrodes 20A and 20B and the configuration material of the conductor portions 31 and 32 may be different from each other.

What is claimed is:

1. A coil component comprising:
a coil portion that has a plurality of ring-shaped planar coil portions individually including a coil-wound portion and an intra insulative layer which covers the periphery of the coil-wound portion within the same layer as the coil-wound portion, an inter insulative layer being interposed between the planar coil portions adjacent to each other in a stacking direction of the planar coil portions, and a pair of extra insulative layers being respectively positioned on one end side and the other end side of the plurality of planar coil portions in the stacking direction; and
a covering portion that covers the coil portion,
wherein in regard to the stacking direction, the thickness of the inter insulative layer is thinner than the thickness of each of the pair of extra insulative layers.

2. The coil component according to claim 1,
wherein when viewed in the stacking direction, the inter insulative layer exhibits a ring shape corresponding to forming regions of the planar coil portions adjacent to each other in the stacking direction.

3. The coil component according to claim 1,
wherein when viewed in the stacking direction, each of the pair of extra insulative layers has a ring-shaped portion corresponding to the forming regions of the planar coil portions adjacent to each other in the stacking direction, and the extra insulative layer positioned on the one end side of the plurality of planar coil portions in the stacking direction has a solid portion filling the inside of the ring-shaped portion.

4. A power supply circuit unit comprising:
the coil component according to claim 1.
